(19) United States
(12) Patent Application Publication
(10) Pub. No.: US 2011/0095998 A1
(43) Pub. Date: Apr. 28, 2011

(54) EXTERNAL INPUT DEVICE

(75) Inventors: Chao Kuo Hsieh, Taipei County (TW); Chia-Cheng Lin, Taipei County (TW)

(73) Assignee: FORTREND TAIWAN SCIENTIFIC CORP., Taipei County (TW)

(21) Appl. No.: 12/607,910

(22) Filed: Oct. 28, 2009

(51) Int. Cl. G06F 3/041

(52) U.S. Cl. 345/173

(57) ABSTRACT

An external input device is disclosed. The external input device comprises an upper case, a touch sensor module, a control module, a lighting module, a transfer module, a transparent substrate, and a lower case. The upper case comprises a visible region and a shielding region; the touch sensor module is provided under the upper case; control module is provided under the shielding region; the lighting module is provided on the control module; the transparent substrate is provided under the touch sensor; and the lower case is used for sitting the touch sensor module, the control module, the lighting module, the transfer module, and transparent substrate, and integrates with the upper case. The external input device can be used for performing pointing mode and key-in mode to replace the functions of mice, touch panel, and partial functions of keyboards, and the external input device is easy to switch between the modes for users.

### BACKGROUND OF THE INVENTION

1. Field of the Invention

The present invention relates generally to an input device, and more particularly, to an external input device.

2. The Prior Arts

Conventionally, keyboards and mice or touch panels are used as user interfaces.

Keyboards know in the prior art are equipped with typewriter keys, cursor control keys, numerical keypads, and a plurality of function keys. Users may use such keyboards to perform inputting letters, inputting numbers, and various built-in functions of computer. However, even though the cursor control keys on the keyboards known in the prior art can be used for controlling the cursor on the screen, a defect of such operation is that the cursor can only be moved within the window in-use and cannot be moved to the toolbars outside the window for performing other functions of the computers. In order to overcome this defect, users need to use mice or touch panels besides keyboards when inputting.

Mice know in the prior art are equipped with left keys and right keys, and sometimes a scrolling wheel in between. Users may use such mice for rapid movement of cursor on screen to perform clicking, opening toolbars, and scrolling windows. However, users need to use both keyboards and mice when inputting for performing various functions of computers, therefore the defect of such operation is that users need to use mice and keyboards back and forth.

Touch panels are used as mice in laptop computers, therefore the touch panels can be used for performing a direct input of handwriting other than the function of mice stated above. However, defect of such operation is that users need to use both keyboards and touch panels back and forth with both hands when inputting for performing various functions of laptop computers, especially when inputting in numbers. For instance, users need to input letters with the typewriter keys first, and then input numbers with numerical keys after performing a switching operation, plus users need to move the cursor by using touch panels of the laptop computers. A switching operation is required between performing inputting letters and inputting numbers or after positioning the cursor with the touch panels. This leads to inconvenience to use keyboards and mice or touch panels for users.

Also, the touch panels of the laptop computers known in the prior art is manufactured by laminating films on printed circuit boards. Due to the fact that gaps, impurities, or bubbles may form between the films and the printed circuit boards during the manufacturing process, situations of poor sensitivity and ill identifiability causing malfunctions to the touch panels are expected.

### SUMMARY OF THE INVENTION

A primary objective of the invention is to provide an external input device comprising an upper case, a touch sensor module, a control module, a lighting module a transfer module, a transparent substrate and a lower case. The upper case comprises a visible region and a shielding region. The touch sensor module is provided under the upper case, and comprises an input region and a first circuit. The touch sensor module is used for receiving a user operation, and generating a user signal according to the user operation. The control module is provided under the shielding region, and comprises a second circuit. The control module is used for receiving the user signal and passing it on. The lighting module is provided on the control module, and comprises at least two light sources for providing at least two distinct colors of light. The transfer module is provided on the control module for transferring the user signal to a computer system. The transparent substrate is provided under the touch sensor module and is provided with a side facing the light sources. The transparent substrate is used for distributing the light and for providing the touch sensor module with supporting protection. The lower case is used for sitting the touch sensor module, the control module, the lighting module, the transfer module and the transparent substrate, and integrates with the upper case.

Users may utilize the external input device of the present invention to perform a key-in mode and a pointing mode. The external input device may replace keyboards known in the prior art under the key-in mode, especially replacing numeric keypads and the function keys of the keyboards known in the prior art; the external input device may replace pointing devices known in the prior art such as tablets, touch panels, trackballs, mice, and joysticks. The touch sensor module further comprises a switching region used for switching between the key-in mode and the pointing mode.

The inventor improves the input devices known in the art with the touch technology, and provides an external input device integrating a pointing device, a tablet, and a numerical keypad, enabling a device to be equipped with functions of pointing, writing, and keying-in for replacing keyboards and mice or touch panels of laptop computers, or for replacing keyboards and mice of desktop computers. The replacement not only helps economizing on hardware manufacturing process and cost but also makes it easier for users to perform input operation with one hand. Also, the sensitivity, identifiability, and accuracy of the input device are greatly improved as well as the problem of electromagnetic interference caused by external moisture to the input device is prevented because of the fact that the external input device of the present invention replaces film lamination known in the prior art with touch technology.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating the external input device of the present invention;

FIG. 2 is an exploded perspective view illustrating the external input device of the present invention;

FIG. 3 is a schematic diagram illustrating the external input device of the present invention under the first mode; and

FIG. 4 is a schematic diagram illustrating the external input device of the present invention under the second mode.

### DETAILED DESCRIPTION OF THE PREFERRED EMBODIMENT

The accompanying drawings are included to provide a further understanding of the present invention, and are incorporated in and constitute a part of this specification. The drawings illustrate embodiments of the present invention and, together with the description, serve to explain the principles of the present invention.

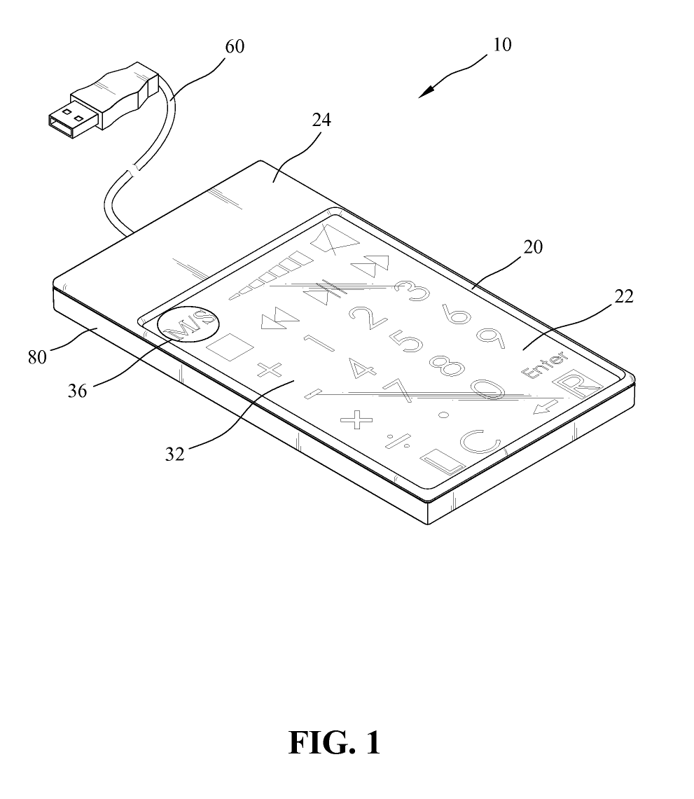

FIG. 1 is a schematic diagram illustrating the external input device of the present invention. The external input device 10 of the present invention at least comprises an upper case 20, a transfer module 60 and a lower case 80. As shown in the figure, the upper case 20 comprises a visible region 22 and a shielding region 24 with a property of opacity. The lower case 80 and the upper case 20 are integrated to form the body of the external input device 10 of the present invention.

The transfer module 60 is provided on a lateral end of the external input device 10, the transfer module 60 is used for transferring signals to a computer system (not shown in the figure), and can be one of the cable module and the wireless module. The cable module comprises one of the DIN connector, DE-9 connector, PS/2 interface, and Universal Serial Bus (USB). The wireless module comprises one of the Bluetooth, Radio Frequency (RF), and Infrared (IR).

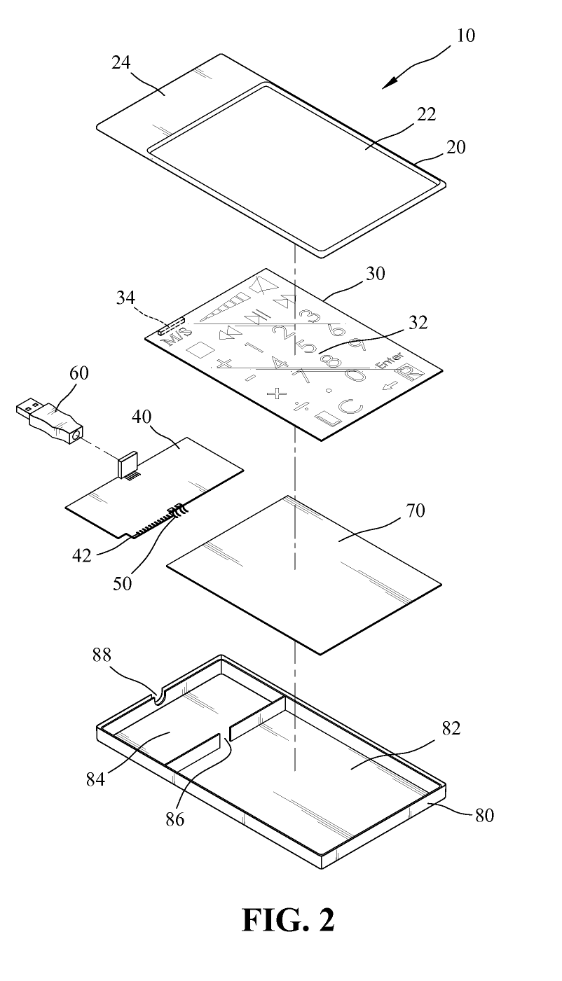

FIG. 2 is an exploded perspective view illustrating the external input device of the present invention. The external input device 10 of the present invention further comprises a touch sensor module 30, a control module 40, a lighting module 50 and a transparent substrate 70. The touch sensor module 30 is provided under the upper case 20, the control module 40 is provided under the shielding region 24 of the upper case 20, the lighting module 50 is provided on the control module 40, the transfer module 60 is provided on the control module 40, and the transparent substrate 70 id provided under the touch sensor module 30.

The touch sensor module 30 comprises an input region 32 and a first circuit 34, wherein the input region 32 comprises at least one switching region 36 therein. The control module 40 comprises a second circuit 42, and both the lighting module 50 and the transfer module 60 are electrically connected to the control module 40 respectively. The control module 40 is used for receiving the user signal and passing it on, as well as performing one of a first mode and a second mode. The lighting module 50 comprises at least two light sources for providing at least two distinct colors of light. The transparent substrate 70 is provided with a side facing the light sources.

The lower case 80 comprises a first sitting region 82, a second sitting region 84, at least one opening 86 and a through hole 88. For illustration purposes, only one opening 86 positioned at the center will be employed in this embodiment as an example, however the lower case 80 may be provided with at least one opening 86 corresponding to the positions of the light sources for directing the light emitted by the light sources to the side of the transparent substrate 70, and the opening 86 can be any size in the application.

Please also refer to FIG. 1, the touch sensor module 30 is provided under the visible region 22 of the upper case 20 and is a light transmissive laminate article; an top surface thereof is used for receiving the user operation by the user, and a bottom surface thereof is provided with at least one of a plurality of numbers, symbols and graphs desired. The user may see the input region 32 of the touch sensor module 30 through the visible region 22 of the upper case 20, and the user may perform the user operation in the input region 32. The touch sensor module 30 may generate a user signal according to the user operation.

The user operation comprises a first switching operation and a second switching operation. The first switching operation is performed by pressing the switching region 36 of the input region 32 with conductive articles such as fingers or touch pens to switch the first mode to the second mode; the second switching operation is performed by pressing the switching region 36 of the input region 32 with conductive articles such as fingers or touch pens to switch the second mode to the first mode.

The user signal comprises a first switching signal and a second switching signal. The first switching signal is generated according to the first switching operation by the touch sensor module 30; the second switching signal is generated according to the second switching operation by the touch sensor module 30.

The switching region 36 is used for switching various modes of the external input device 10. For illustration purposes, only one switching region 36 on the upper left corner will be employed in this embodiment as an example, however the external input device 10 may be provided with at least one switching region 36 positioned at any location desired in the input region 32. When in use, the user may switch the external input device 10 between the first mode and the second mode by performing a switching operation in the switching region 36.

The input region 32 of the touch sensor module 30 can be seen through the visible region 22, whereas the first circuit 34 of the touch sensor module 30 and the control module 40 are shielded under the shielding region 24. The second circuit 42 of the control module 40 corresponds to the first circuit 34 of the touch sensor module 30. The touch sensor module 30 on the transparent substrate 70 is electrically connected to the second circuit 42 of the control module 40 via the first circuit 34 to transfer the user signal generated by the touch sensor module 30.

The first sitting region 82 of the lower case 80 is used for sitting the transparent substrate 70, whereas the second sitting region 84 of the lower case 80 is used for sitting the control module 40. When the transfer module 60 is a cable module, the transfer module 60 connects the cable module to the computer system (not shown in the figure) via the through hole 88 of the lower case 80. The lighting module 50 is extended from the control module 40 and positioned at the opening 86 of the lower case 80 for emitting the light to the side of the transparent substrate 70.

The aforesaid transparent substrate 70 plays roles of protection and light distribution. The transparent substrate 70 distributes the light emitted by the lighting module 50 to the entire transparent substrate 70 with its light distribution ability, so that the light is radiated to the touch sensor module 30 on the transparent substrate 70, allowing the user to see a plurality of numbers, symbols or graphs shown on the touch sensor module 30 through the visible region 22. Moreover, the transparent substrate 70 provides the touch sensor module 30 with supporting protection, preventing damages to the touch sensor module 30 caused by external forces exerted thereon.

The aforesaid transparent substrate 70 comprises one of the polymethylmethacrylate (PMMA), polycarbonate (PC), polyethylene (PE) and polyethylene terephthalate (PET).

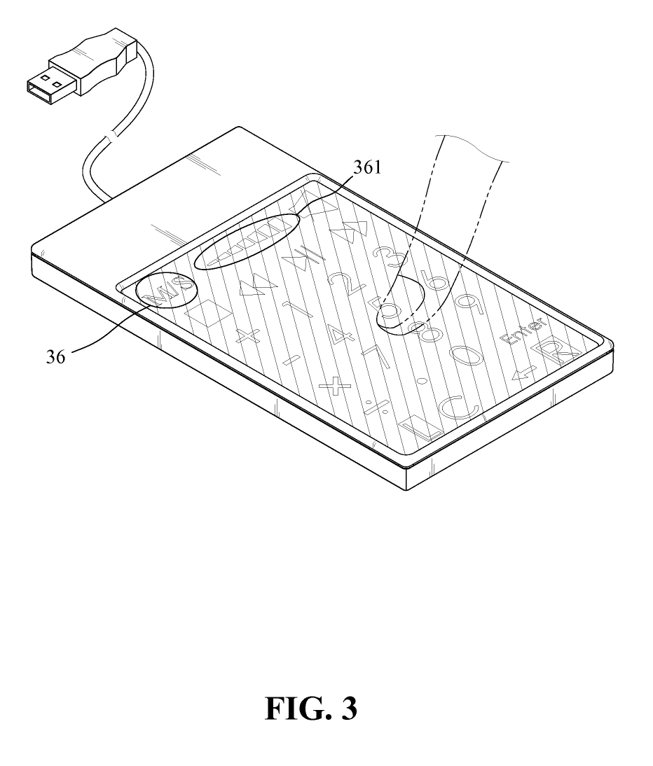

FIG. 3 is a schematic diagram illustrating the external input device of the present invention under the first mode. The oblique lines shown in the figure represent a luminous region seen by the user, and the light seen is a first light provided by the lighting module 50.

When the external input device 10 is under the first mode performed by the control module 40, the input region 32 of the touch sensor module 30 comprises at least one function region 361. For illustration purposes, only one function region 361 at the upper center will be employed in this embodiment as an example, however the external input device 10 may be provided with at least one function region 361 positioned at any location desired in the input region 32. The input region 32 is used for performing number inputting function, whereas the function region 361 is used for performing an additional function. The additional function comprises at least one of the functions of calculation, media control and volume adjustment.

The aforesaid user operation further comprises a first touch operation and a first dragging operation under the first mode. The first touch operation is performed by pressing at least one of the input region 32 and the function region 361 with conductive articles such as fingers or touch pens; the first dragging operation is performed by gliding arbitrarily in the function region 361 with conductive articles such as fingers or touch pens.

The aforesaid user signal further comprises a first touch signal and a first dragging signal under the first mode. The first touch signal is generated according to the first touch operation by the touch sensor module 30; the first dragging signal is generated according to the first dragging operation by the touch sensor module 30.

The user makes touch sensor module 30 generate the first touch signal by performing the first touch operation in the input region 32. The first touch signal is transferred to the control module 40 via the first circuit 34 through the second circuit 42, so that it is further transferred to the computer system (not shown in the figure) via the transfer module 60 on the control module 40.

In this embodiment, the user may perform volume adjustment by the first dragging operation in the function region 361.

Under the first mode, the external input device 10 of the present invention may replace partial functions of keyboards known in the prior art, especially the numerical keypads and the function keys.

When the user performs the first switching operation in the switching region 36, the first switching signal is generated by the touch sensor module 30. The first switching signal is transferred to the lighting module 50 on the control module 40 via the first circuit 34 through the second circuit 42, so that the lighting module 50 generates a second light according to the first switching signal, and the external input device 10 is switched to the second mode at the same time.

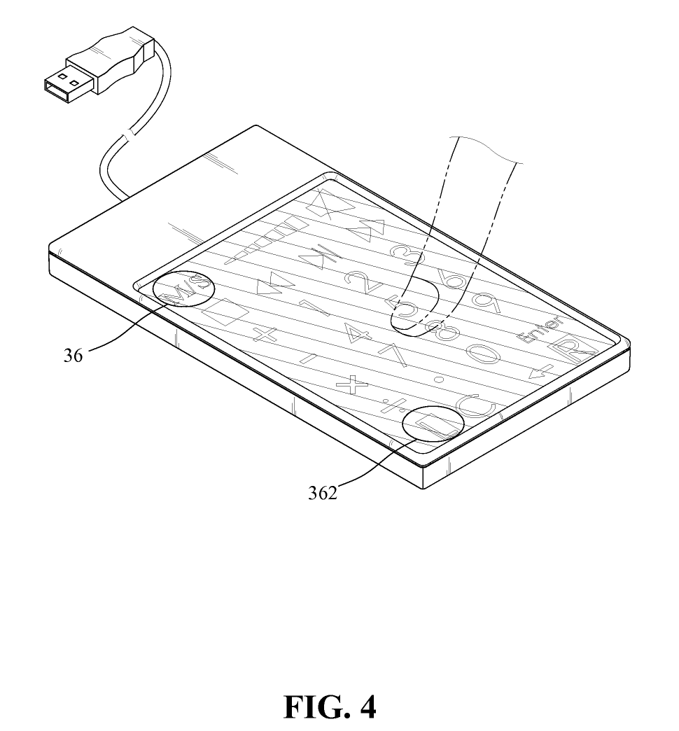

FIG. 4 is a schematic diagram illustrating the external input device of the present invention under the second mode. The oblique lines shown in the figure represent a luminous region seen by the user, and the light seen is a second light provided by the lighting module 50.

When the external input device 10 is under the second mode performed by the control module 40, the input region 32 of the touch sensor module 30 comprises at least one clicking region 362. For illustration purposes, only one clicking region 362 on the bottom left corner will be employed in this embodiment as an example, however the external input device 10 may be provided with at least one clicking region 362 positioned at any location desired in the input region 32. The input region 32 is used for performing cursor control, whereas the clicking region 362 is used for performing an extension function. The extension function comprises at least one of the functions of clicking, window scrolling, positioning, and toolbar control.

The aforesaid user operation further comprises a second touch operation and a second dragging operation under the second mode. The second touch operation is performed by pressing at least one of the input region 32 and the clicking region 362 with conductive articles such as fingers or touch pens; the second dragging operation is performed by gliding arbitrarily in the input region 32 with conductive articles such as fingers or touch pens.

The aforesaid user signal further comprises a second touch signal and a second dragging signal under the second mode. The second touch signal is generated according to the second touch operation by the touch sensor module 30; the second dragging signal is generated according to the second dragging operation by the touch sensor module 30.

The user makes touch sensor module 30 generate the second dragging signal by performing the second dragging operation in the input region 32. The second dragging signal is transferred to the control module 40 via the first circuit 34 through the second circuit 42, so that it is further transferred to the computer system (not shown in the figure) via the transfer module 60 on the control module 40.

In this embodiment, the user may control the position of a cursor displayed on computer screen or input handwritings by the second dragging operation.

When the cursor on computer screen is moved to a desired position, the user may select items needed displayed on eh screen by performing the second touch operation in the clicking region 362.

Under the second mode, the external input device 10 of the present invention may replace pointing devices known in the prior art such as tablets, touch panels, trackballs, mice, and joysticks.

When the user performs the second switching operation in the switching region 36, the second switching signal is generated by the touch sensor module 30. The second switching signal is transferred to the lighting module 50 on the control module 40 via the first circuit 34 through the second circuit 42, so that the lighting module 50 generates the first light according to the second switching signal, and the external input device 10 is switched to the first mode at the same time.

In the embodiment illustrated above, the external input device 10 is switched between the first mode and the second mode, where the first mode and the second mode are the key-in mode and the pointing mode, respectively. However, the first mode and the second mode are only used for illustration purposes and are not used for limiting the modes performed by the external input device 10.

Moreover, in the embodiment illustrated above, the first light and the second light emitted by the lighting module 50 under the first mode and the second mode are a red light and a blue light, respectively. However, the red light and the blue light are only used for illustration purposes, and are not used for limiting the color of the light emitted by the lighting module 50. The first light and the second light can be any color, and the color of the first light is distinct from the color of the second light.

The external input device of the present invention replaces film lamination known in the prior art with touch technology, so that the sensitivity, identifiability, and accuracy of the input device are greatly improved as well as the problem of electromagnetic interference caused by external moisture to the input device is prevented. Also, the external input device of the present invention integrates a pointing device, a tablet, and a numerical keypad, enabling a device to be equipped with functions of pointing, writing, and keying-in. When in use, the user may switch and use at least one of the first mode and the second mode in the same input device. The external input device of the present invention may replace numerical pads, function keys, tablets, touch panels, trackballs, mice, and joysticks of computer systems known in the prior art. The replacement not only helps economizing on hardware manufacturing process and cost but also makes it easier for users to switch between the first mode and the second mode.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An external input device, comprising:
an upper case comprising a visible region and a shielding region;
a touch sensor module for receiving a user operation and generating a user signal according to the user operation, the touch sensor module is provided under the upper case and comprises an input region and a first circuit;
a control module for receiving the user signal, passing it on, performing one of a first mode and a second mode, and is provided under the shielding region and comprises a second circuit;
a lighting module provided on the control module comprises at least two light sources for providing at least two distinct colors of light;
a transfer module provided on the control module for transferring the user signal to a computer system, the transfer module is one of a cable module and a wireless module;
a transparent substrate with a side facing the light sources provided under the touch sensor module for distributing the light, so that the light is directed to the touch sensor module, and providing the touch sensor module with supporting protection; and
a lower case for sitting the touch sensor module, the control module, the lighting module, the transfer module and the transparent substrate and integrating with the upper case.

2. The external input device according to claim 1, wherein the lower case comprises:
a first sitting region with the transparent substrate sitting herein;
a the second sitting region with the control module sitting therein; and
at least one opening corresponding to the positions of the light sources for directing the light emitted by the light sources to the side of the transparent substrate.

3. The external input device according to claim 1, wherein the lower case comprises:
a first sitting region with the transparent substrate sitting herein;
a the second sitting region with the control module sitting therein;
at least one opening corresponding to the positions of the light sources for directing the light emitted by the light sources to the side of the transparent substrate; and
a through hole for sitting the cable module.

4. The external input device according to claim 1, wherein the touch sensor module further comprises a top surface and a bottom surface, the top surface is used for receiving the user operation performed by conductive articles, the bottom surface is provided with at least one of a plurality of numbers, symbols and graphs desired.

5. The external input device according to claim 1, wherein the second circuit corresponds to the first circuit and is electrically connected to the first circuit.

6. The external input device according to claim 1, wherein the cable module comprises at least one of the DIN connector, DE-9 connector, PS/2 interface, and Universal Serial Bus, the wireless module comprises at least one of the Bluetooth, Radio Frequency, and Infrared.

7. The external input device according to claim 1, wherein the transparent substrate comprises one of the polymethylmethacrylate, polycarbonate, polyethylene and polyethylene terephthalate.

8. The external input device according to claim 1, wherein
the input region is used for performing number inputting function under the first mode performed by the control module, the touch sensor module further comprises at least one function region under the first mode, each the function region is used for performing an additional function, the additional function comprises at least one of the functions of calculation, media control and volume adjustment;
the input region is used for performing cursor control under the second mode performed by the control module, the touch sensor module further comprises at lest one clicking region under the second mode, each the clicking region is used for performing an extension function, the extension function comprises at least one of the functions of clicking, window scrolling, positioning, and toolbar control; and
the input region further comprises a switching region for switching between the first mode and the second mode.

9. The external input device according to claim 8, wherein the lighting module emits a first light under the first mode and emits a second light under the second mode, wherein the color of the first light is distinct from the color of the second light.

10. The external input device according to claim 8, wherein the user operation comprises:
a first touch operation comprising pressing at least one of the input region and the function region with the conductive articles;
a first dragging operation comprising gliding arbitrarily in the function region with the conductive articles;
a first switching operation comprising pressing the switching region with the conductive articles;
a second touch operation comprising pressing the clicking region with the conductive articles;
a second dragging operation comprising gliding arbitrarily in the input region with the conductive articles; and
a second switching operation comprising pressing the switching region with the conductive articles.

11. The external input device according to claim 8, wherein the user signal comprises:
a first touch signal generated according to the first touch operation by the touch sensor module;
a first dragging signal generated according to the first dragging operation by the touch sensor module;
a first switching signal generated according to the first switching operation by the touch sensor module;
a second touch signal generated according to the second touch operation by the touch sensor module;
a second dragging signal generated according to the second dragging operation by the touch sensor module; and
a second switching signal generated according to the second switching operation by the touch sensor module.

12. The external input device according to claim 11, wherein
at least one of the first touch signal and the first dragging signal is transferred to the control module via the first circuit through the second circuit under the first mode, so that it is further transferred to the computer system via the transfer module on the control module; and
the first switching signal is transferred to the lighting module on the control module via the first circuit through the second circuit under the first mode,
the lighting module generates a second light according to the first switching signal, and the external input device is switched to the second mode.

13. The external input device according to claim 11, wherein
at least one of the second touch signal and the second dragging signal is transferred to the control module via the first circuit through the second circuit under the second mode, so that it is further transferred to the computer system via the transfer module on the control module; and
the second switching signal is transferred to the lighting module on the control module via the first circuit through the second circuit under the second mode, the lighting module generates the first light according to the second switching signal, and the external input device is switched to the first mode.

14. The external input device according to claim 4, wherein the conductive articles comprise one of fingers and touch pens.
